(19) United States
(12) Patent Application Publication
(10) Pub. No.: US 2019/0151866 A1
(43) Pub. Date: May 23, 2019

(54) KITCHEN AND BATHROOM DEVICE WITH ENERGY-SAVING AND EFFICIENT WATER SPRAY

(71) Applicant: XIAMEN EASO CO., LTD., Xiamen (CN)

(72) Inventors: Haitao Lu, Xiamen (CN); Zhen Li, Xiamen (CN); Yuebin Yang, Xiamen (CN); Ximin Chen, Xiamen (CN)

(21) Appl. No.: 15/963,081

(22) Filed: Apr. 25, 2018

(30) Foreign Application Priority Data
Nov. 22, 2017 (CN) 201711173245.4

(51) Int. Cl. B05B 1/16; B05B 1/18

(52) U.S. Cl. CPC B05B 1/1672; B05B 1/18

(57) ABSTRACT

A kitchen and bathroom device with energy-saving and efficient water spray includes a water outlet panel and nozzles arranged on the water outlet panel. The nozzles each have a water outlet hole at a front end thereof The nozzles each have two spaced water outlet passages therein, defined as an ordinary water outlet passage and a variational water outlet passage and obliquely disposed at two sides of a centerline of the water outlet hole to form included angles with the centerline of the water outlet hole, respectively. The ordinary water outlet passage communicates with the water outlet hole to spray ordinary water. The variational water outlet passage communicates with the water outlet hole to spray variational water.

### BACKGROUND OF THE INVENTION

### 1. Field of the Invention

The present invention relates to a bathroom accessory, and more particularly to a kitchen and bathroom device with energy-saving and efficient water spray.

### 2. Description of the Prior Art

Water outlet devices, such as shower heads, pull-out faucets, etc., have various shapes and styles. The water spray of the water outlet device is affected by the water pressure. When the water pressure is high, the water flow is strong and the spray area is relatively large. When the water pressure is low, the water flow is weak, the spray area is small, the scouring force is weak, and the use effect is not ideal. In the prior art, in order to overcome the problem of low water pressure, some of water outlet devices are provided with a pressurizing structure therein. The internal structure of the water outlet device is complicated and the production cost is high Another way is to adjust the water spray effect through the change of the diameter of the water outlet hole. When the water pressure is low, the water flows through the small holes in the water outlet panel to form impact water flow with a certain pressure so as to maintain a better water spray mode. When the water pressure is high, the water flows through the large holes in the water outlet panel to reduce the flow rate of the water so as to reduce the impact force and make the water spray soft and comfortable. In this way, the water outlet panel must be provided with both small holes and large holes, and the production process is complicated. When in use, the water outlet panel can only select the small holes or the large holes to spray water. The water outlet area is limited, and the water spray effect is poor. Accordingly, the inventor of the present invention has devoted himself based on his many years of practical experiences to solve these problems.

### SUMMARY OF THE INVENTION

In view of the drawbacks of the prior art, the primary object of the present invention is to provide a kitchen and bathroom device with energy-saving and efficient water spray. Through the improvement of the structure, the kitchen and bathroom device can correspond to the change of the high and low water pressures to provide a better water spray effect.

In order to achieve the aforesaid object, the present invention adopts the following technical solution. A kitchen and bathroom device comprises a water outlet panel and nozzles an arranged on the water outlet panel. The nozzles each have a water outlet hole at a front end thereof The nozzles each have two spaced water outlet passages therein, defined as an ordinary water outlet passage and a variational water outlet passage. The ordinary water outlet passage and the variational water outlet passage are obliquely disposed at two sides of a centerline of the water outlet hole to form included angles with the centerline of the water outlet hole, respectively. The ordinary water outlet passage communicates with the water outlet hole to spray ordinary water. The variational water outlet passage communicates with the water outlet hole to spray variational water.

Preferably, each of the included angles is greater than 0° and less than 90°.

Preferably, the nozzles are arranged on the water outlet panel depending on the sizes of the included angles in accordance with the law of increasing or diminishing

Preferably, the water outlet hole at the front end of each nozzle is a single hole. The ordinary water outlet passage and the variational water outlet passage selectively communicate with the water outlet hole.

Alternatively, the water outlet hole at the front end of each nozzle includes two holes. The two holes correspond to and communicate with the ordinary water outlet passage and the variational water outlet passage, respectively.

Preferably, the nozzles are evenly or annularly disposed on the water outlet panel.

Preferably, the variational water is sprayed out in a two-by-two intersecting mode.

Preferably, the variational water is sprayed out in a focalization mode.

With the above structure, the nozzles of the water outlet panel of the present invention is formed with the ordinary water outlet passage corresponding to the normal water pressure and the variational water outlet passage corresponding to the low water pressure. When in use, the water channels can be switched to communicate with the corresponding water outlet passage to spray normal water or variational water in a focalization mode according to the water pressure or individual needs. In the case of lower water pressure, the focalized variational water is sprayed out to maintain strong scouring force and effectively solve the problem of poor water outflow effect. The novel structure of the present invention is particularly applicable to an environment with unstable water pressure.

### BRIEF DESCRIPTION OF THE DRAWINGS

FIG. 1 is a sectional view of the present invention;

FIG. 1A is a partial enlarged view of FIG. 1;

FIG. 2 is a schematic view in accordance with a first embodiment of the present invention, showing an ordinary water outflow state;

FIG. 3 is a schematic view in accordance with the first embodiment of the present invention, showing a focalized water outflow state;

FIG. 4 is a schematic view in accordance with a second embodiment of the present invention;

FIG. 5 is a schematic view in accordance with the second embodiment of the present invention, showing an ordinary water outflow state;

FIG. 6 is a schematic view in accordance with the second embodiment of the present invention, showing a focalized water outflow state;

FIG. 7 is a schematic view of the water outlet hole in the form of a dual hole configuration of the present invention, showing an ordinary water outflow state;

FIG. 7A is a partial enlarged view of FIG. 7;

FIG. 8 is a schematic view of the water outlet hole in the form of a dual hole configuration of the present invention, showing a focalized water outflow state;

FIG. 9 is a schematic view of the present invention, showing that the variational water is focalized in the form of a small circle;

FIG. 10 is a schematic view of the present invention, showing that the variational water is focalized in a broom-like shape; and

FIG. 11 is a schematic view of the present invention, showing that the variational water is sprayed out in a two-by-two intersecting mode.

### DETAILED DESCRIPTION OF THE PREFERRED EMBODIMENTS

Embodiments of the present invention will now be described, by way of example only, with reference to the accompanying drawings.

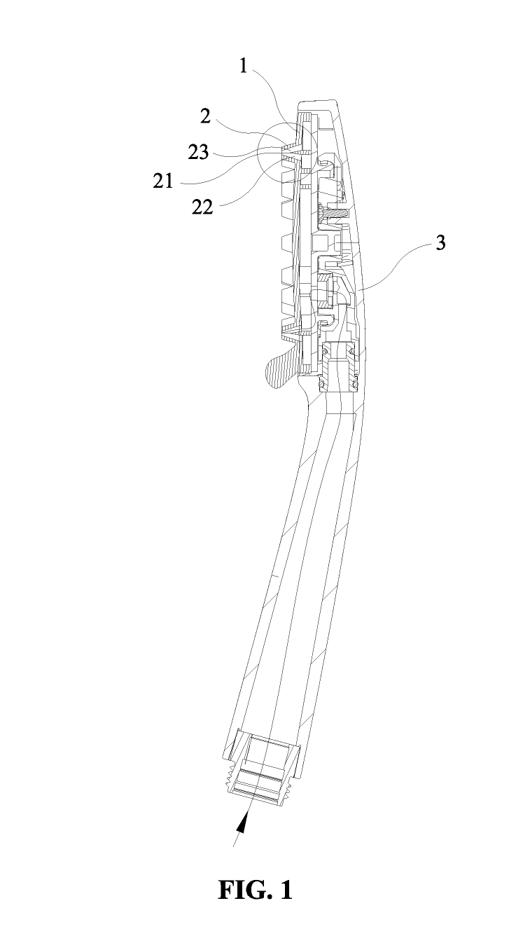

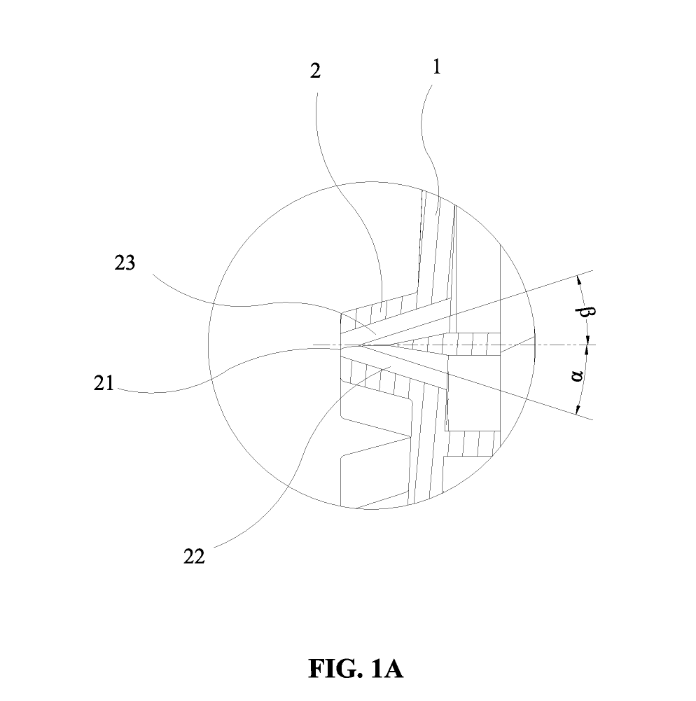

As shown in FIG. 1 to FIG. 7, a kitchen and bathroom device with energy-saving and efficient water spray comprises a water outlet panel 1 and nozzles 2 arranged on the water outlet panel 1.

At least one group of the nozzles 2 is evenly or annularly disposed on the water outlet panel 2. The nozzles 2 each have a water outlet hole 21 at a front end thereof In particular, the nozzles 2 each have two spaced water outlet passages therein, defined as an ordinary water outlet passage 22 and a variational water outlet passage 23. The ordinary water outlet passage 22 and the variational water outlet passage 23 are obliquely disposed at two sides of the centerline of the water outlet hole 21. An included angle α is defined between the ordinary water outlet passage 22 and the centerline of the water outlet hole 21. An included angle β is defined between the variational water outlet passage 23 and the centerline of the water outlet hole 21. Each of the included angle α and the included angle β is greater than 0° and less than 90°. The sizes of the included angles α and β can determine the mode of the water spray. The ordinary water outlet passage 22 communicates with the water outlet hole 21 to spray ordinary water. The variational water outlet passage 23 communicates with the water outlet hole 21 to spray variational water in a focalization mode.

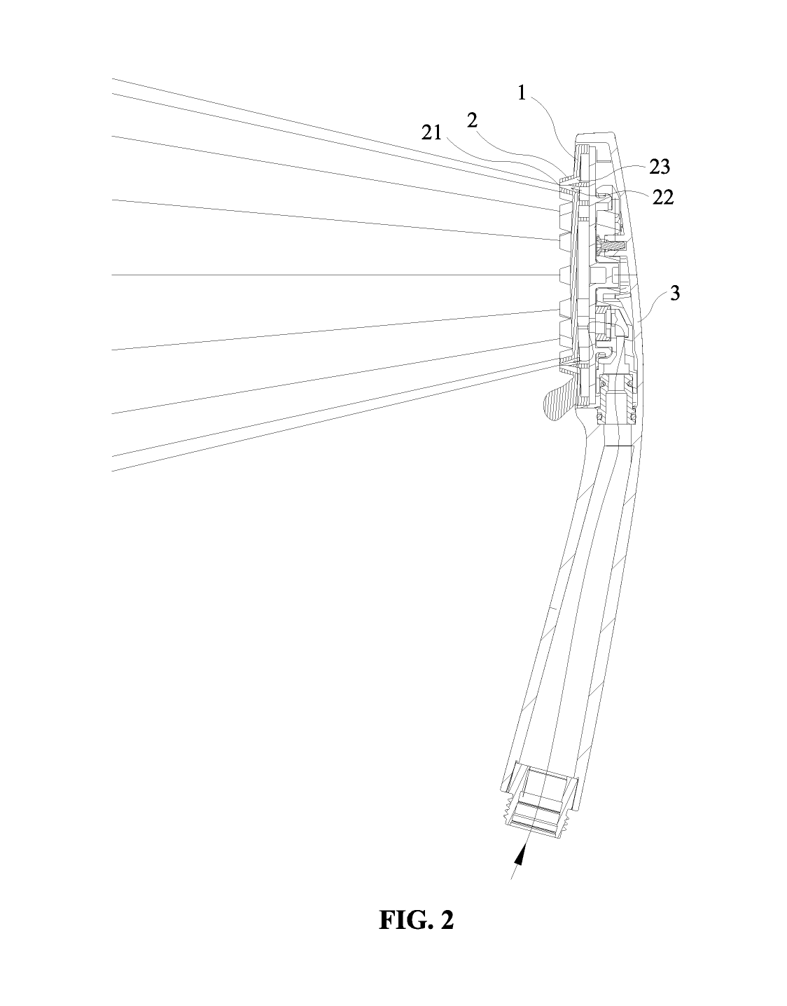

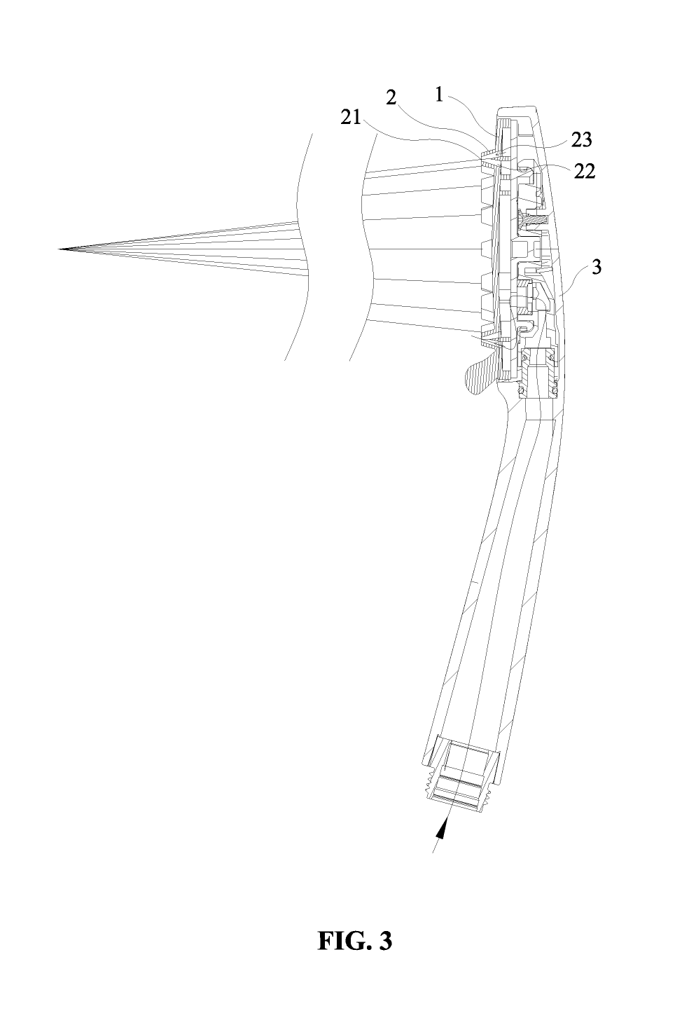

The variational water structure of the present invention can be applied to a shower head, a faucet, a spray gun and other water outlet devices. In a first embodiment of the present invention, the variational water structure is applied to a shower head 3. The water outlet panel 1 is mounted to the shower head 3. The interior of the shower head 3 is provided with corresponding water channels in communication with the ordinary water outlet passage 22 and the variational water outlet passage 23. The two water channels are switched through a switching structure provided inside the shower head 3. The switching structure adopts the prior art. In use, as shown in FIG. 2, when the water pressure is normal, the water channel of the ordinary water outlet passage 22 is opened, and the variational water outlet passage 23 is closed. The water passes through the ordinary water outlet passage 22 and flows out from the water outlet hole 21 to spray ordinary water. The shower head 3 sprays water in a flared mode. When the water pressure is low, as shown in FIG. 3, the switching structure is operated to open the water channel of the variational water outlet passage 23. The water passes through the variational water outlet passage 23 and flows out from the water outlet hole 21. The shower head 3 sprays water in a focalization mode.

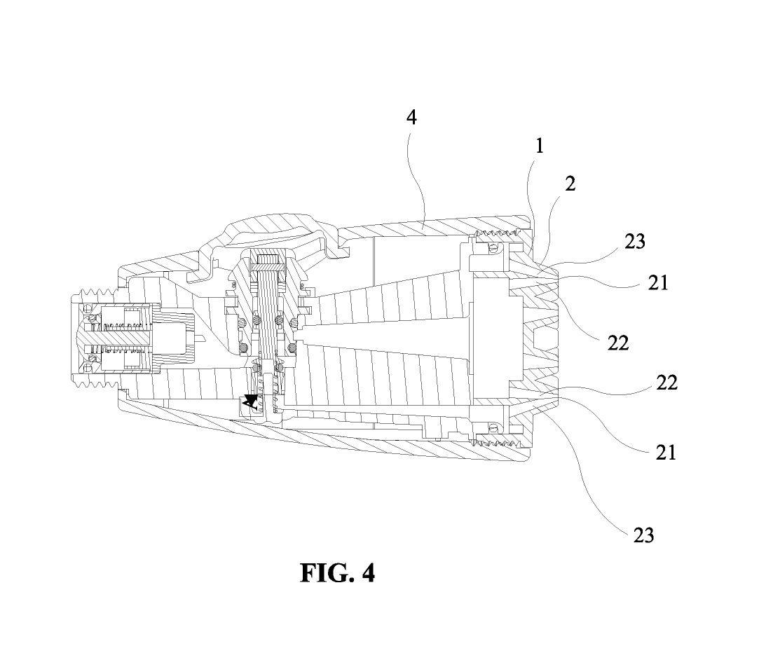

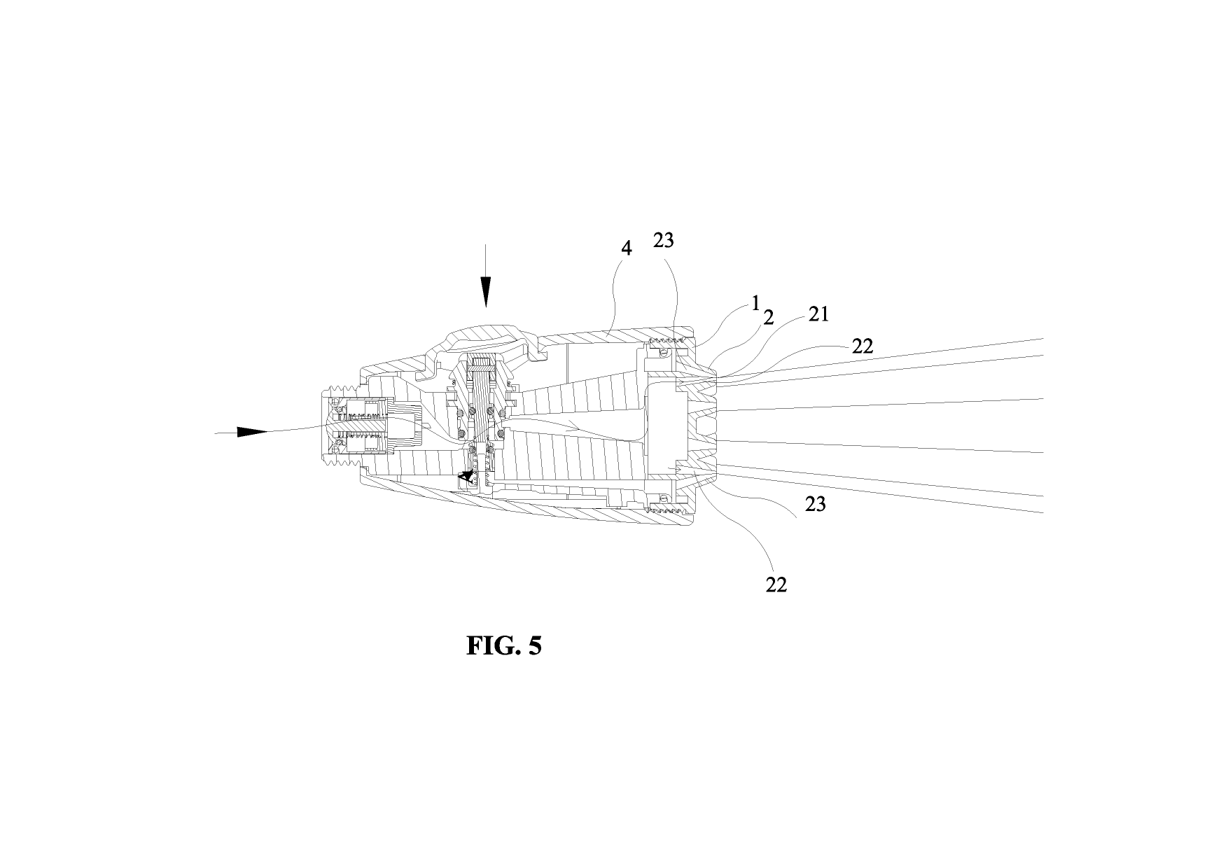

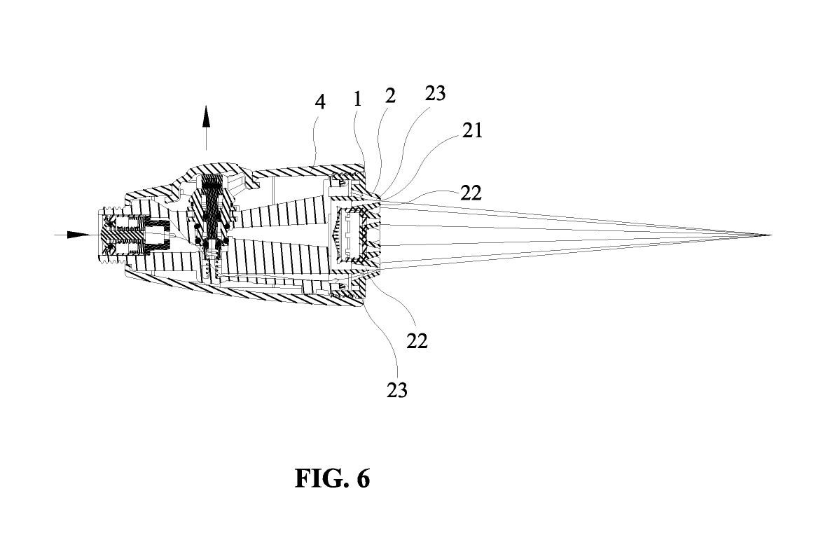

In a second embodiment of the present invention, the variational water structure is applied to a pull-out faucet 4. The water outlet panel 1 is mounted to the pull-out faucet 4. As shown in FIGS. 4 and 5, when the water pressure is normal, the water channel of the ordinary water outlet passage 22 of the nozzle of the water outlet panel is opened, and the variational water outlet passage 23 is dosed. The water passes through the ordinary water outlet passage 22 and flows out from the water outlet hole 21. The pull-out faucet 4 sprays water in a flared mode. When the water pressure is low, as shown in FIG. 6, the switching structure is operated to open the water channel of the variational water outlet passage 23, and the ordinary water outlet passage 22 is closed. The water passes through the variational water outlet passage 23 and flows out from the water outlet hole 21. The pull-out faucet 4 sprays water in a focalization mode.

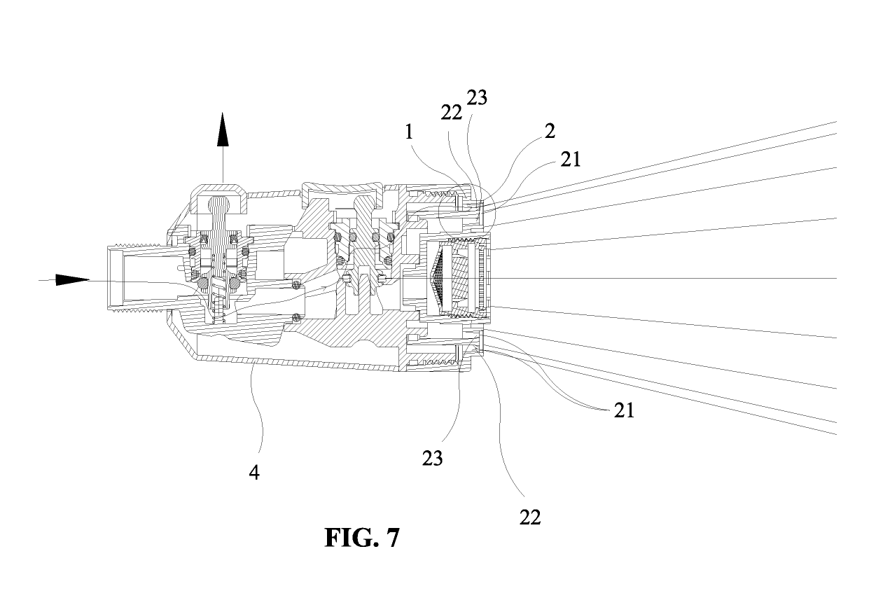

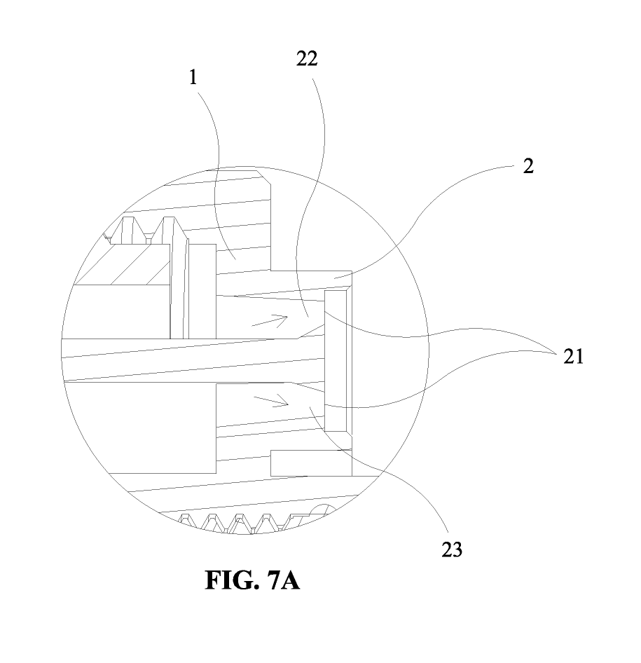

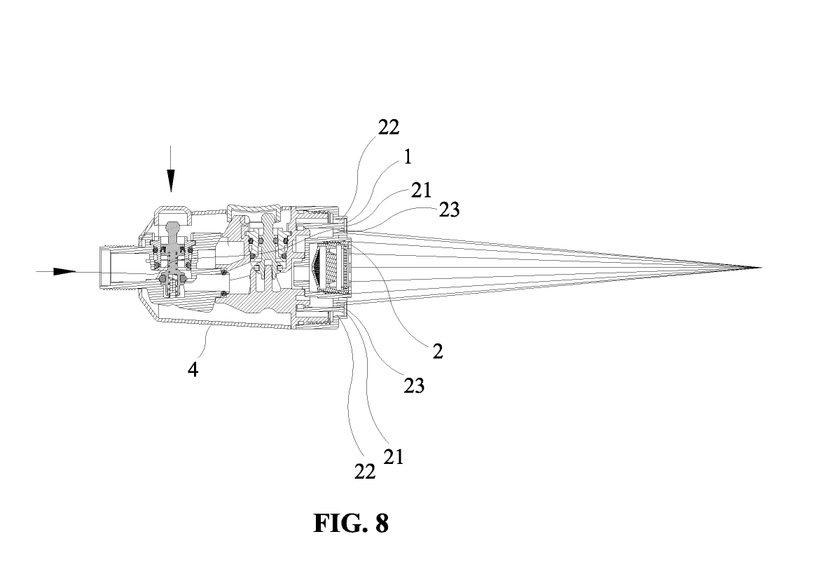

The water outlet hole 21 at the front end of the nozzle 2 of the present invention may be a single hole configuration or a double hole configuration. When the water outlet hole 21 is a single hole configuration, the ordinary water outlet passage 22 and the variational water outlet passage 23 selectively communicate with the water outlet hole 21 to spray ordinary water or variational water. When the water outlet hole 21 is a double hole configuration, as shown in FIGS. 7, 7A and 8, the two holes of the water outlet hole correspond to and communicate with the ordinary water outlet passage 22 and the variational water outlet passage 23 respectively to spray ordinary water or variational water.

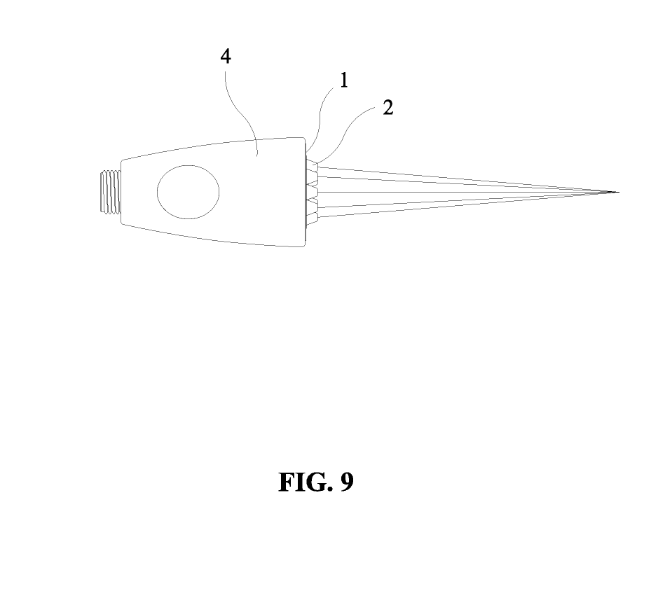

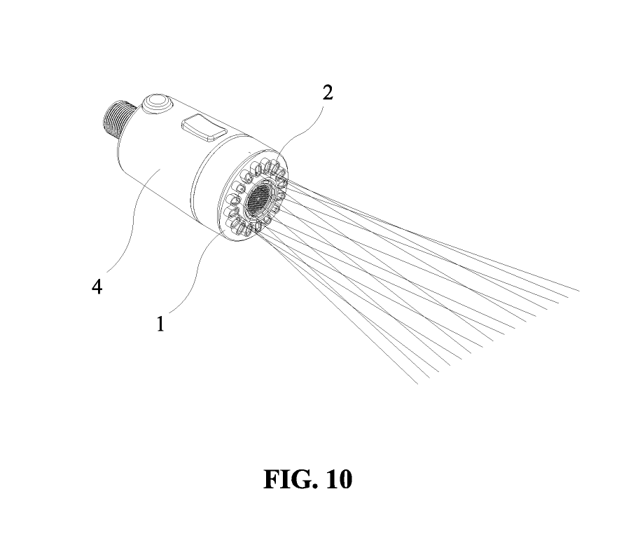

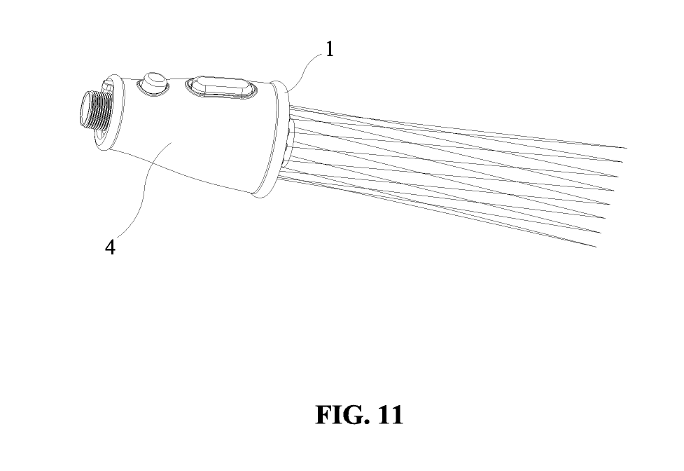

It should be noted that the included angle α between the ordinary water outlet passage 22 and the centerline of the outlet hole 21 and the included angle β between the variational water outlet passage 23 and the centerline of the outlet hole 21 in the present invention can be set according to the requirements during manufacture. The nozzles are arranged on the water outlet panel of the shower head depending on the sizes of the included angles in accordance with the law of increasing or diminishing or other laws to spray water in different modes. As shown in FIG. 9 and FIG. 10, the nozzles are arranged according to a certain rule to spray and focalize water in the form of a small circle or in a broom-like shape. As shown in FIG. 11, the nozzles can spray water in a two-by-two intersecting mode.

With the above structure, the nozzles of the water outlet panel of the shower head of the present invention is formed with the ordinary water outlet passage corresponding to the normal water pressure and the variational water outlet passage corresponding to the low water pressure. When in use, the water channels can be switched to communicate with the corresponding water outlet passage to spray normal water or variational water in a focalization mode according to the water pressure or individual needs. In the case of lower water pressure, the focalized variational water is sprayed out to maintain strong scouring force and effectively solve the problem of poor water outflow effect. The novel structure of the present invention is particularly applicable to an environment with unstable water pressure.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A kitchen and bathroom device, comprising a water outlet panel and nozzles arranged on the water outlet panel; the nozzles each having a water outlet hole at a front end thereof, the nozzles each having two spaced water outlet passages therein, defined as an ordinary water outlet passage and a variational water outlet passage; the ordinary water outlet passage and the variational water outlet passage being obliquely disposed at two sides of a centerline of the water outlet hole to form included angles with the centerline of the water outlet hole respectively; the ordinary water outlet passage communicating with the water outlet hole to spray ordinary water, the variational water outlet passage communicating with the water outlet hole to spray variational water.

2. The kitchen and bathroom device as claimed in claim 1, wherein each of the included angles is greater than 0° and less than 90°.

3. The kitchen and bathroom device as claimed in claim 1, wherein the nozzles are arranged on the water outlet panel depending on the sizes of the included angles in accordance with the law of increasing or diminishing

4. The kitchen and bathroom device as claimed in claim 1, wherein the water outlet hole at the front end of each nozzle is a single hole, the ordinary water outlet passage and the variational water outlet passage selectively communicate with the water outlet hole.

5. The kitchen and bathroom device as claimed in claim 1, wherein the water outlet hole at the front end of each nozzle includes two holes, and the two holes correspond to and communicate with the ordinary water outlet passage and the variational water outlet passage, respectively.

6. The kitchen and bathroom device as claimed in claim 1, wherein the nozzles are evenly or annularly disposed on the water outlet panel.

7. The kitchen and bathroom device as claimed in claim 1, wherein the variational water is sprayed out in a two-by-two intersecting mode.

8. The kitchen and bathroom device as claimed in claim 1, wherein the variational water is sprayed out in a focalization mode.
